(19) United States
(12) Patent Application Publication
(10) Pub. No.: US 2015/0034790 A1
(43) Pub. Date: Feb. 5, 2015

(54) SUPPORT APPARTUS AND ROTATIONAL POSTION RETURN APPARATUS

(71) Applicant: HITACHI AUTOMOTIVE SYSTEMS, LTD, Ibaraki (JP)

(72) Inventors: Takahiro TSUBOI, Fukushima-shi (JP); Hirokatsu NAITO, Date-shi (JP); Shingo IWATANI, Fukushima-shi (JP)

(21) Appl. No.: 14/330,414

(22) Filed: Jul. 14, 2014

(30) Foreign Application Priority Data
Jul. 30, 2013 (JP) 157898/2013

(51) Int. Cl. F16M 11/20; A47C 3/18; A47C 3/30; F16M 11/28

(52) U.S. Cl. CPC F16M 11/2014; F16M 11/28; A47C 3/185; A47C 3/30
USPC 248/404; 248/417

(57) ABSTRACT

Provided is a support apparatus including a support tube, a support column inserted in the support tube, and a rotational position return mechanism provided between the support tube and the support column to return the support column rotated relative to the support tube to a reference position in response to a reduction in rotational torque applied to one end of the support column.

### BACKGROUND OF THE INVENTION

The present invention relates to a support apparatus and a rotational position return apparatus.

A chair capable of adjusting the height position of its seat part, for example, is provided with a support apparatus comprising a gas spring device supporting the seat part vertically movably (for example, see Japanese Patent Laid-Open Publication No. 2013-50201).

The gas spring device used in the support apparatus of the type described above allows adjustment of the height of the chair by sliding a piston, together with a piston rod, or a cylinder mechanism through a lever operation. In addition, the gas spring device supports the seat part rotatably.

In the gas spring device, for example, the cylinder body of the cylinder mechanism is supported rotatably relative to the leg part of the chair, and the piston rod projecting axially from the cylinder body is secured to the leg part. In addition, the gas spring device is provided with a rotational position return mechanism (also known as an “auto-return mechanism”) allowing the seat part to return to a reference position (forward-facing position) when the load (occupant's weight) having been applied to the seat part disappears.

The rotational position return mechanists comprises a guide member secured in a support tube, a rotating member rotating in response to the rotation of the cylinder body, a vertically movable member movable only in the axial direction, and a spring member urging the vertically movable member in the axial direction so that a first inclined surface of the vertically movable member and a second inclined surface of the rotating member abut against each other face-to-face. With the gas spring device, when a seated occupant leaves the chair in a state where the seat part has been rotated in the circumferential direction from a state where the occupant seats on the chair to change the direction thereof, the rotating member rotates about its own axis so that the first inclined surface of the vertically movable member and the second inclined surface of the rotating member abut against each other face-to-face, thereby allowing the seat part to return to a reference position where the seat part faces a predetermined direction.

### SUMMARY OF INVENTION

In the above-described rotational position return mechanism, the rotating member is rotatable through 360°; therefore, the seat part is allowed to return to the reference position (forward-facing position) when the load (occupant's weight) having been applied to the seat part disappears, regardless of the rotational position of the seat part as rotated. In this regard, however, when the spacing between chairs is relatively narrow, for example, in a conference hall or a lecture room, the seat parts of mutually adjacent chairs may contact each other, and a seated occupant may also contact the neighboring occupant. In such a case, if the seat part rotates excessively and the occupant or the seat part contacts the neighboring occupant when he or she leaves or sits on the chair, they may be left in an awkward situation.

The present invention has been made in view of the above-described circumstances. Accordingly, an object of the present invention is to provide a support apparatus and a rotational position return apparatus, which are configured to solve the above-described problem.

To solve the above-described problem, the present invention has the following features.

The present invention provides a support, apparatus including a support tube receiving an axial load, and a support column inserted in the support tube such that one end of the support column projects out of one end of the support tube to support the load, and that the other end of the support column is axially secured to the other end of the support tube. The one end of the support column is rotatable relative to the support tube. The support apparatus further includes a rotational position return mechanism provided between the support tube and the support column to return the support column rotated relative to one support tube to a reference position in response to a redaction in rotational torque applied to the one end of the support column. The rotational position return mechanism has a guide member non-rotatably secured in the support tube and having the support column rotatably extending therethrough. The guide member has a first inclined surface formed on one axial end thereof. The rotational position return mechanism further has a rotating member having a second inclined surface facing the first inclined surface of the guide member. The rotating member is rotatable together with the support column and axially movable relative to the support column. Further, the rotational position return mechanism has an urging member urging the rotating member axially toward the guide member, and a limiter limiting the axial movable range of the rotating member.

According to the present invention, a limiter is provided to limit the axial movable range of the rotating member. Therefore, it is possible to limit the rotatable range of the rotating member when performing a rotational position return operation, and hence possible to narrow the range within which the first inclined surface of the guide member and the second inclined surface of the rotating member are rotatable relative to each other. Accordingly, when the support apparatus is used to support the seat part of a chair, for example, it is possible to limit the maximum rotational angle of the seat part to less than a predetermined angle.

### BRIEF DESCRIPTION OF DRAWINGS

FIG. 1 is an illustration of a chair to which an embodiment of a support apparatus according to the present invention is applied.

FIG. 2 is a vertical sectional view of the support apparatus.

FIG. 3 is a vertical sectional view for explaining the operation of a rotational position return mechanism.

FIG. 4 is a vertical sectional view showing the structure of a second embodiment of the present invention.

FIG. 5 is a vertical sectional view showing the structure of a third embodiment of the present invention.

FIG. 6 is a fragmentary vertical sectional view showing the structure of a fourth embodiment of the present invention.

### DESCRIPTION OF EMBODIMENTS

Embodiments of the present invention will be explained below with reference to the accompanying drawings.

### First Embodiment

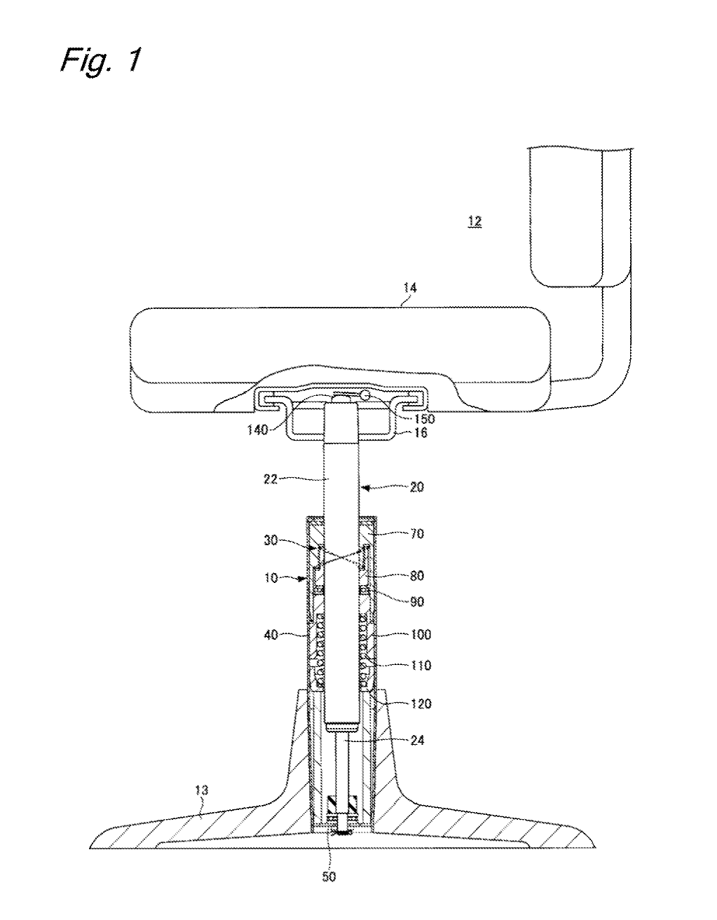

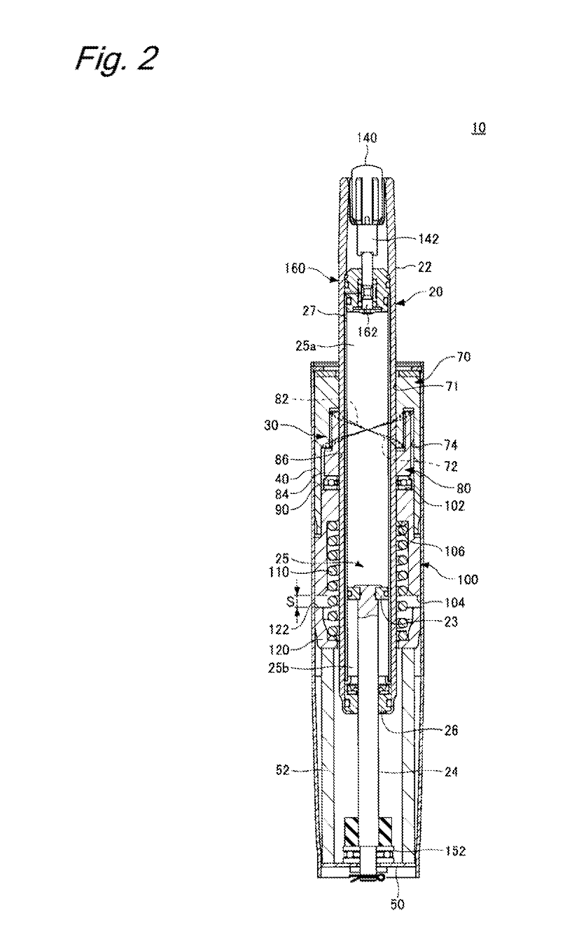

FIG. 1 is an illustration showing a chair 12 to which an embodiment of a support apparatus according to the present invention is applied. FIG. 2 is a vertical sectional view of the support apparatus. As shown in FIGS. 1 and 2, a support apparatus (rotational position return apparatus) 10 has a cylinder mechanism (support column) 20, a rotational position return mechanism 30, and a support tube (outer tube) 40.

The cylinder mechanism 20 is a gas spring device including a cylinder body 22 having a gas sealed therein at a predetermined pressure, and a piston rod 24 connected to a piston 23 slidable in the cylinder body 22.

The cylinder body 22 is rotatable relative to the support tube 40 formed in the shape of a circular cylinder, one end of which is closed. The upper end of the cylinder body 22 projects upward from the upper end of the support tube 40 and is secured to a bracket 16 supporting a seat part 14. The lower end of the piston rod 24 is secured through a bearing 152 to a bottom plate 50 provided in the bottom of the support tube 40.

The rotational position return mechanism 30 is provided in a tubular space formed between the inner periphery of the support tube 40 and the outer periphery of the cylinder body 22. The rotational position return mechanism 30 allows the facing direction of the seat part 14 to be changed in the rotational direction to return to a reference position. The rotational position return mechanism 30 automatically returns the facing direction of the seat part 14 to a predetermined direction (forward-facing reference position) when an occupant rises from the seat part 14 (i.e. when the rotational torque acting on the cylinder mechanism 20 decreases). The rotational position return mechanism 30 comprises a guide member 70, a rotating member 80, a bearing 90, a rotation limiting member 100, a spring member (urging member) 110, a spring retainer 120, and so forth.

The guide member 70 is non-rotatably secured to the inner periphery of the support tube 40 by caulking or the like. The guide member 70 has a bearing bore 71 through which the cylinder body 22 extends. Through the bearing bore 71, the guide member 70 guides the cylinder body 22 in both sliding and rotating directions. The inner periphery of the guide member 70 is provided with a recess 74 accommodating the rotating member 60 fitted to the outer periphery of the cylinder body 22.

The bearing 90 is a thrust bearing disposed between the lower end 84 of the rotating member 80 and the upper end 102 of the rotation limiting member 100 to reduce resistance to the rotation of the rotating member 80 even when an axial load is applied to the rotating member 80 from an occupant seated on the seat part 14. It should be noted that the rotating member 80 has a central bore 86 in which the cylinder body 22 is fitted. The central bore 86 is fitted onto the cylinder body 22 so that the rotating member is axially slidable relative to the outer periphery of the cylinder body 22, and the rotating member 80 is rotatable together with the cylinder body 22.

The rotation limiting member 100 has an upper end 102 abutting against the lower end of the bearing 90. The rotation limiting member 100 further has a lower end 104 facing the upper end of the spring retainer 120, and a stepped portion 106 against which the upper end of the spring member 110 abuts. The rotation limiting member 100 limits the axial movable range of the rotating member 80 to limit the rotatable range of the rotating member 80 and hence to limit the rotatable range of the seat part 14. The rotation limiting member 100 limits the rotatable range of the rotating member 80 to a desired range by the axially projecting position thereof. More specifically, the rotatable range of the rotating member 80 is limited by the separation S between the lower end 104 of the rotation limiting member 100 and the upper end 122 of the spring retainer 120.

For example, when the separation S is increased, the rotatable range of the rotating member 80 and the seat part 14 increases, whereas, when the separation S is reduced, the rotatable range of the rotating member 80 and the seat part 14 decreases. Accordingly, properly setting the separation S makes it possible to narrow the range within which a first inclined surface 72 of the guide member 70 and a second inclined surface 82 of the rotating member 80 are rotatable relative to each other, and hence possible to limit the maximum rotational angle of the seat part 14 to less than a predetermined angle.

The rotating member 80 is fitted to the outer periphery of the cylinder body 22. Therefore, the rotating member 80 is retained so as to rotate together with the cylinder body 22 as one unit and supports the cylinder body 22 movable only in the axial direction. In addition, the rotating member 80 has on the upper end thereof a second inclined surface (cam surface) 82 abutting against and separating from a first inclined surface (cam surface) 72 of the guide member 70. Consequently, the rotating member 80 is rotatable about its own axis and also axially movable, with the second inclined surface (cam surface) 82 slidingly contacting the first inclined surface (cam surface) 72 of the guide member 70. It should be noted that, in FIG. 2, the rotating member 80 is in an upward-moved position where the first inclined surface 72 and the second inclined surface 82 face each other in the same inclination direction; therefore, the seat part 14 is in a reference position (forward-facing reference position).

The spring member 110 abuts at the lower end thereof against the spring retainer 120 secured to the support tube 40 by caulking and abuts at the upper end thereof against the stepped portion 106 of the rotation limiting member 100, thereby pressing the rotating member 80 upward through the bearing 90. Thus, the spring member 110 urges the rotating member 80 upward through the rotation limiting member 100 and the bearing 90, thereby urging the respective inclined surfaces 82, 72 of the rotating member 80 and the guide member 70 to abut against each other face-to-face. The spring retainer 120 is secured at a predetermined height position by caulking the support tube 40. In addition, a tubular spacer 52 is inserted between the bottom plate 50 and the spring retainer 120 to support the spring retainer 120.

Thus, the rotating member 80 is pressed upward by the spring force of the spring member 110. Therefore, as the second inclined surface 82 of the rotating member 80 is pressed against the first inclined surface 72 of the guide member 70, the rotating member 80 rotates circumferentially and stops at a position where the two inclined surfaces abut against each other face-to-face. Thus, the rotational position return mechanism 30 is configured to return the seat part 14 to the reference position by cooperation of the rotating member 80 pressed upward by the spring force of the spring member 110 and the guide member 70 fixedly secured to the support tube 40.

### Structure of Cylinder Mechanism 20

Here, let us explain the structure of the cylinder mechanism 20. The cylinder mechanism 20 has a cylinder body 22 and a combination of a piston 23 and a piston rod 24, which are inserted in the cylinder body 22 so as to be axially movable so that the piston rod can enter into the cylinder body and exit from the cylinder body 22. The cylinder mechanism 20 further has a plunger 140 slidably projecting from the upper end opening of the cylinder body 22. When the plunger 140 is pressed downward by an external operation of a control lever 150, for example, the plunger 140 descends into the cylinder body 22, thereby allowing adjustment of the height of the seat part 14.

Further, the cylinder body 22 has a cylinder chamber 25 formed therein in which the piston 23 slides axially. Further, the cylinder body 22 has a bearing part 26 fitted to the lower end thereof. The piston rod 24 having the piston 23 extends axially through the bearing part 26. The lower end of the piston rod 24 is secured to the bottom plate 50 of the support tube 40. The cylinder chamber 25 comprises an upper chamber 25a and a lower chamber 25b, which are filled with an inert compressed gas.

The upper and lower chambers 25a and 25b of the cylinder chamber 25 are communicated with each other through a gas flew path 27. When the gas flow path 27 is cut off, the piston 23 stops. When the plunger 140 opens the gas flow path 27, the piston 23 is pressed downward by the difference in pressure-receiving area between the upper and lower surfaces of the piston 23.

The plunger 140 is provided at the lower end thereof with a valve mechanism 160 selectively opening and closing the gas flow path 27. The valve mechanism 160 has a spool 162 slidable in a passage communicating with the gas flow path 27. The spool 162 of the valve mechanism 160 is fitted at the upper end thereof into a shaft portion 142 of the plunger 140. The spool 162 moves to an open position (communicating position) as the plunger 140 is pressed downward.

Accordingly, when the control lever 150 is actuated to press the plunger 140 to open the gas flow path 27 in a state where the seat part 14 is unloaded, the upper and lower chambers 25a and 25b of the cylinder chamber 25 are communicated with each other, and the piston 23 is pressed downward relative to the cylinder body 22, thereby enabling the height position of the seat part 14 to be raised.

When the control lever 150 is actuated to press the plunger 140 to open the gas flow path 27 in a state where the seat part 14 is loaded with an occupant, the piston rod 24 is pressed back into the cylinder body 22 relative to the latter by the weight of the seated occupant, thereby enabling the height position of the seat part 14 to be lowered.

The rotatable range of the seat part 14 is determined by the relative rotation of the first inclined surface 72 of the guide member 70 and the second inclined surface 82 of the rotating member 80. The rotatable range of the seat part 14 is also determined by the relative vertical movement of the first inclined surface 72 of the guide member 70 and the second inclined surface 82 of the rotating member 80. That is, the axial movable range of the rotating member 80 is limited by the presence of the rotation limiting member 100 interposed between the guide member 70 and the rotating member 80; therefore, the rotatable range of the seat part 14 is limited to less than a predetermined angle by setting the axial length (height) of the rotation limiting member 100 to a given size.

The following is an explanation of the operation of the rotational position return mechanism 30 when an occupant seated on the seat part 14 rotates the seat part 14 to leave the chair 12.

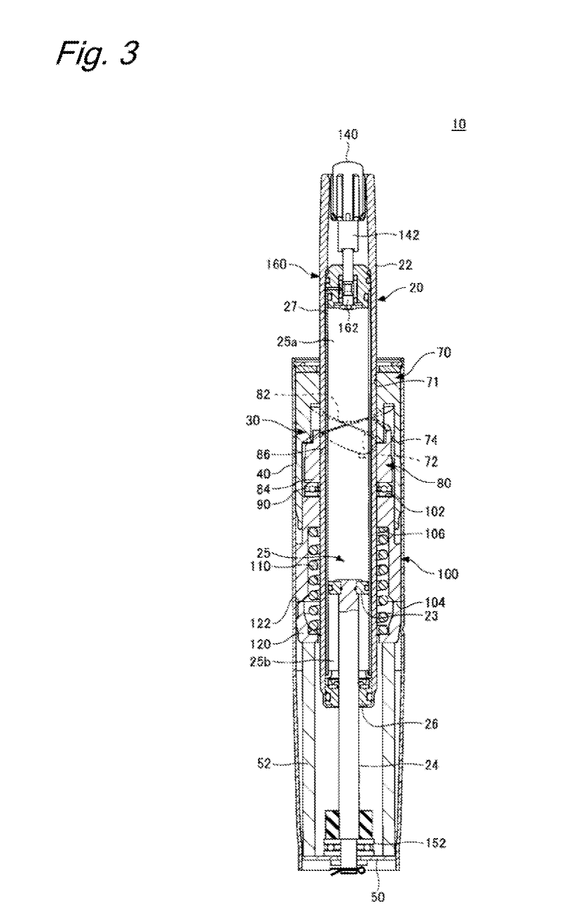

FIG. 3 is a vertical sectional view for explaining the operation of the rotational position return mechanism. As shown in FIG. 3, when the cylinder body 22 rotates about its own axis as the seat part 14 rotates, the second inclined surface 82 of the rotating member 80 rotates relative to the first inclined surface 72 of the guide member 70. Consequently, the mutually facing positions of the first inclined surface 72 and the second inclined surface 82 are displaced as the seat part 14 rotates, and at the same time, the rotating member 80 descends, sliding on the outer periphery of the cylinder body 22.

As the rotating member 80 descends, the bearing 90 and the rotation limiting member 100, which are disposed below the rotating member 80, slide downward. As the rotation limiting member 100 descends axially, the spring member 110 is compressed by receiving a compressing load. When the lower end 104 of the rotation limiting member 100 abuts against the upper end 122 of the spring retainer 120, the rotating member 80 is stopped from descending further. Consequently, the rotation of the cylinder body 22 and the seat part 14 is restrained.

Thus, the maximum rotatable range of the seat part 14 is limited to a predetermined rotational angle by the axial slidable range (corresponding to the separation S) of the rotation limiting member 100. Accordingly, even when an occupant rotates the seat part 14 to sit on or leave the chair 12, for example, in a place where the spacing between mutually adjacent chairs 12 is narrow, his or her chair 12 is prevented from contacting the neighboring chair 12.

When an occupant leaves the chair 12 in a state where the seat part 14 has been rotated, the load having been applied to the seat part 14 and the cylinder body 22 disappears, and at the same time, the rotation limiting member 100 is pressed upward by the spring force of the spring member 110, causing the rotating member 80 to slide also upward through the bearing 90. As the rotating member 80 slides upward in this way, the second inclined surface 82 of the rotating member 80 rotates so as to assume the same inclination direction as the first inclined surface 72 of the guide member 70.

When the second inclined surface 82 of the rotating member 80 reaches a rotational position where the second inclined surface 82 faces the first inclined surface 72 of the guide member 70 in the same inclination direction, the rotation of the seat part 14 stops. Thus, the axial sliding motion caused by the spring force of the spring member 110 is converted into rotary motion, thereby allowing the seat part 14 to return to the reference position where the seat part 14 faces forward.

### Second Embodiment

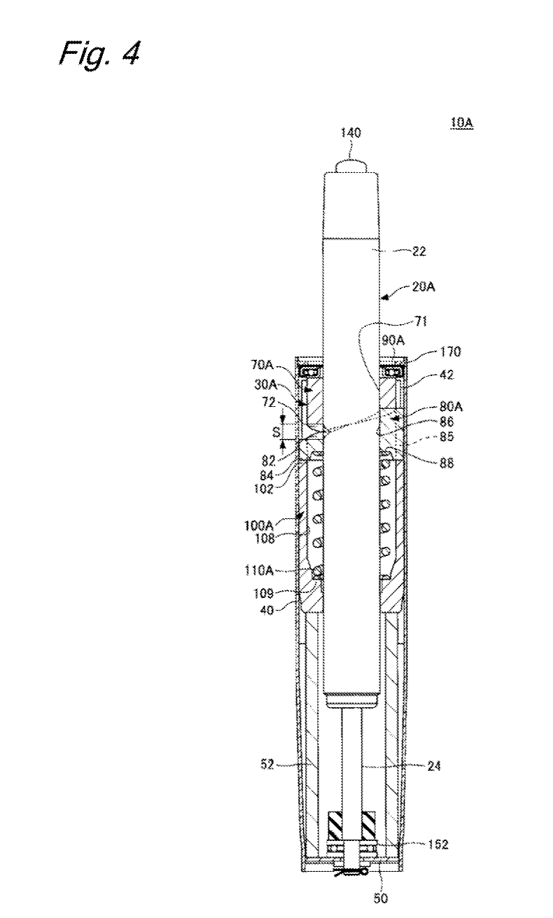

FIG. 4 is a vertical sectional view showing the structure of a second embodiment of the present invention. As shown in FIG. 4, a support apparatus (rotational position return apparatus) 10A has a cylinder mechanism (support column) 20, a rotational position return mechanism 30A, and a support tube (outer tube) 40. It should be noted that the cylinder mechanism 20 and the support tube 40 are similar in structure to those of the first embodiment; therefore, an explanation thereof is omitted. The internal structure of the cylinder body 22 is also similar to that of the first embodiment; therefore, an explanation thereof is omitted.

The rotational position return mechanism 30A comprises a guide member 70A, a rotating member 80A, a bearing 90A, a rotation limiting member 100A, a spring member (urging member) 110, and so forth. The rotation limiting member 100A is configured to serve also as a spring retainer. That is, in the second embodiment, the rotation limiting member 100A and the spring retainer 120 of the first embodiment are integrated into one unit. The bearing 90A is provided between the upper end of the guide member 70A and a retaining ring 170 preventing axial dislodgement of the bearing 90A.

The guide member 70A is fitted at the inner periphery 71 thereof to the outer periphery of the cylinder body 22 and rotatable relative to the support tube 40. The guide member 70A has the cylinder body 22 axially slidably fitted to the inner periphery 71 and is rotatable about its own axis, together with the cylinder body 22.

The rotating member 80A has a second inclined surface 82 facing a first inclined surface 72 of the guide member 70A. The rotating member 80A further has a lower end 84 facing the upper end 102 of the rotation limiting member 100A, and a central bore 86 fitted to the outer periphery of the cylinder body 22. Further, the rotating member 80A has a spring retaining recess 88 provided inside the lower end 84. The upper end of the spring member 110A abuts against the spring retaining recess 88.

The rotating member 80A has the cylinder body 22 axially slidably fitted to the central bore 86, and the central bore 86 is rotatably fitted to the outer periphery of the cylinder body 22. In addition, the rotating member 80A has on the outer periphery thereof engagement portions 85

(shown by the broken lines in FIG. 4) engaged with projecting portions 42 provided on the inner periphery of the support tube 40. It should be noted that the projecting portions 42 extend axially and therefore restrain rotation of the rotating member 80A when sliding axially.

Accordingly, when the cylinder body 22 rotates as the seat part 14 rotates, relative rotation occurs between the first inclined surface 72 of the guide member 70A and the second inclined surface 82 of the rotating member 80A. Consequently, the rotary motion of the guide member 70A is converted into axial sliding motion of the rotating member 80A. In FIG. 4, the rotating member 80A has moved axially downward. In this position, the lower end 84 of the rotating member 80A abuts against the upper end 102 of the rotation limiting member 100A, thus restraining further rotation of the seat part 14.

In FIG. 4, the separation S between the first inclined surface 72 of the guide member 70A and the second inclined surface 82 of the rotating member 80A is the axial slidable distance of the rotating member 80A. Accordingly, properly setting the separation S makes it possible to narrow the range within which the first inclined surface 72 of the guide member 70A and the second inclined surface 82 of the rotating member 80A are rotatable relative to each other, and hence possible to limit the maximum rotational angle of the seat part 14 to less than a predetermined angle.

The rotation limiting member 100A is formed in a tubular shape and provided therein with a recess 108 accommodating the spring member 110A. At the lower end of the recess 108 is provided a spring retaining portion 109 against which the lower end of the spring member 110A abuts.

The rotational position return mechanism 30A having the above-described structure need not be provided with a spring retaining member separately because the rotation limiting member 100A has the spring retaining portion 109. Accordingly, it is possible to reduce the parts count and the manufacturing cost correspondingly.

It should be noted that the return operation when an occupant leaves the chair 12 in a state where the seat part 14 has been rotated is the same as in the first embodiment; therefore, an explanation thereof is omitted.

### Third Embodiment

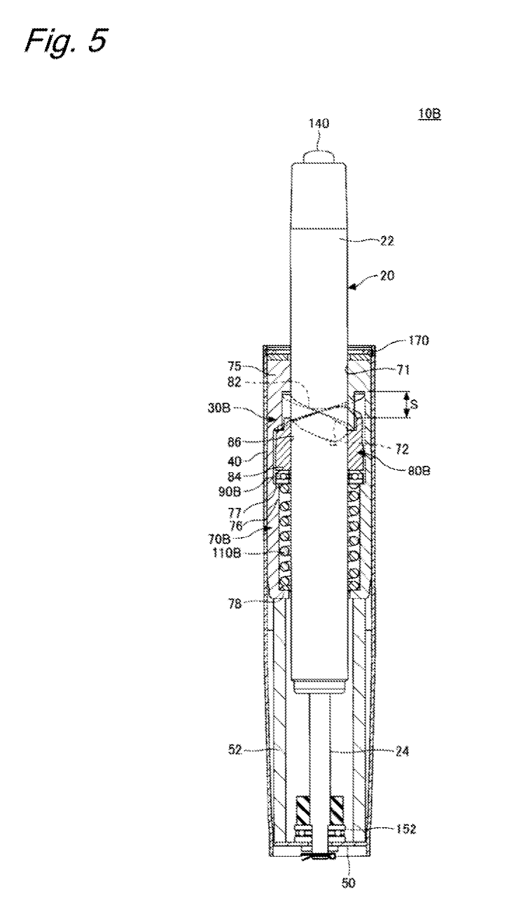

FIG. 5 is a vertical sectional view showing the structure of a third embodiment of the present invention. As shown in FIG. 5, a support apparatus (rotational position return apparatus) 10B has a cylinder mechanism (support column) 20, a rotational position return mechanism 30B, and a support tube (outer tube) 40. It should be noted that the cylinder mechanism 20 and the support tube 40 are similar in structure to those of the first embodiment; therefore, an explanation thereof is omitted. The internal structure of the cylinder body 22 is also similar to that of the first embodiment; therefore, an explanation thereof is omitted.

The rotational position return mechanism 30B comprises a guide and limiting member 70B, a rotating member 80B, a bearing 90B, a spring member (urging member) 110B, and so forth. The guide and limiting member 70B has a guide portion 75, a rotation limiting portion 76, and a spring retaining portion 78.

The guide portion 75 of the guide and limiting member 70B is fitted at the inner periphery 71 thereof to the outer periphery of the cylinder body 22 and rotatable relative to the support tube 40. The guide portion 75 has the cylinder body 22 axially slidably fitted to the inner periphery 71 and is rotatable about its own axis, together with the cylinder body 22.

The rotation limiting portion 76 of the guide and limiting member 70B has a stepped portion 77 abutting against the lower end of the bearing 90B. The axial position of the stepped portion 77 defines the axial sliding position of the rotating member 80B. The stepped portion 77 is formed at a height position determined by the axial length of the rotation limiting portion 76. Accordingly, when the stepped portion 77 is set at a higher position, the axial slidable distance of the rotating member 80B shortens; therefore, the rotatable range of the seat part 14 narrows. When the stepped portion 77 is set at a lower position, the axial slidable distance of the rotating member 80B lengthens; therefore, the rotatable range of the seat part 14 widens.

The rotating member 80B has a second inclined surface 82 facing a first inclined surface 72 formed on the guide portion 75 of the guide and limiting member 70B. The rotating member 80B further has a lower end 84 abutting against the upper end of the bearing 90B, and a central bore 86 fitted to the outer periphery of the cylinder body 22.

The lower end of the bearing 90B is abutted by the upper end of the spring member 110B. Accordingly, the spring force of the spring member 110B acts on the rotating member 80B through the bearing 90B as an urging force for performing a rotational position return operation.

The bearing 90B is interposed so that the spring force of the spring member 110B does not act as a rotational load on the rotating member 80B. The bearing 90B also serves as a limiting member that limits the sliding position of the rotating member 80B by abutting against the stepped portion 77 of the rotation limiting portion 76.

In FIG. 5, the separation S between the first inclined surface 72 of the guide and limiting member 70B and the second inclined surface 82 of the rotating member 80B is an axial slidable distance of the rotating member 80B. Accordingly, properly setting the separation S makes it possible to narrow the range within which the first inclined surface 72 of the guide and limiting member 70B and the second inclined surface 62 of the rotating member 80B are rotatable relative to each other, and hence possible to limit the maximum rotational angle of the seat part 14 to less than a predetermined angle.

In the rotational position return mechanism 30B having the above-described structure, the guide and limiting member 70B has the guide portion 75, the rotation limiting portion 76, and the spring retaining portion 78. Therefore, the rotational position return mechanism 30B need not be provided with a spring retaining member and a rotation limiting member separately. Accordingly, it is possible to reduce the parts count and the manufacturing cost correspondingly.

It should be noted that the return operation when an occupant leaves the chair 12 in a state where the seat part 14 has been rotated is the same as in the first embodiment; therefore, an explanation thereof is omitted.

### Fourth Embodiment

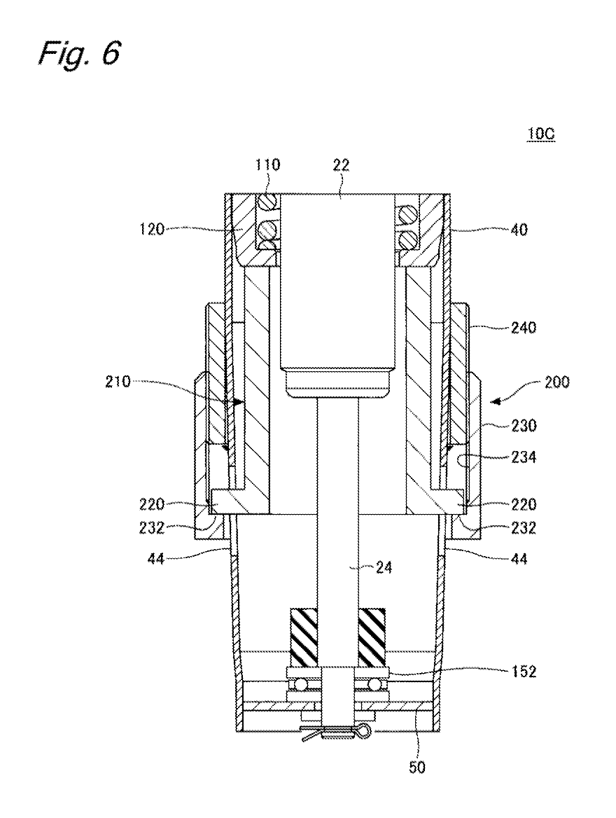

FIG. 6 is a fragmentary vertical sectional view showing the structure of a fourth embodiment of the present invention. It should be noted that FIG. 6 shows only the structure of the lower part of a support apparatus 10C in a fragmentary enlarged view. The structure of the upper part of the support apparatus 10C is similar to that of the foregoing first embodiment; therefore, an explanation thereof is omitted.

As shown in FIG. 6, the support apparatus 10C has an adjusting mechanism 200 for adjusting the height position of a spring retainer 120. The adjusting mechanism 200 has a tubular member 210 connected to the bottom of the spring retainer 120, a pair of projections 220 projecting sideward (radially) from the lower end of the tubular member 210, an adjusting thread member 230 engaged with the projections 220, and an externally threaded part 240 secured to the outer periphery of the support tube 40.

The pair of projections 220 project out of the support tube 40 through respective slits 44 provided in the support tube 40. The adjusting thread member 230 has an abutting portion 232 abutting from below against the respective end portions of the pair of projections 220, and an internally threaded portion 234 thread-engaged with the externally threaded part 240. Because the internally threaded portion 234 is in thread-engagement with the externally threaded part 240, the adjusting thread member 230 moves axially when rotated externally.

The adjusting thread member 230, when rotated right-handed (clockwise), for example, causes the pair of projections 220 to move upward. When rotated left-handed (counterclockwise), the adjusting thread member 230 causes the pair of projections 220 to move downward. Accordingly, as the adjusting thread member 230 is rotated, the axial height position of the spring retainer 120 is adjusted through the tubular member 210 having the pair of projections 220. That is, the rotatable range of the rotating member 80 is limited by the separation S (see FIG. 1) between the lower end 104 of the rotation limiting member 100 and the upper end 122 of the spring retainer 120, and the separation S is adjusted to a desired value by adjusting the axial position of the spring retainer 120. Therefore, properly setting the separation S makes it possible to narrow the range within which the first inclined surface 72 of the guide member 70 and the second inclined surface 82 of the rotating member 80 are rotatable relative to each other, and hence possible to limit the maximum rotational angle of the seat part 14 to less than a predetermined angle.

Therefore, a desired rotatable range of the seat part 14 can be set by properly rotating the adjusting thread member 230 according to the rotatable range to be set.

In the foregoing embodiments, a mechanism for limiting rotation is provided in the support apparatus; therefore, the present invention can be readily applied to an existing chair by simply changing the support column without the need to improve the seat part and so forth of the existing chair. Accordingly, when it is necessary to limit the rotation of only a chair at an end of a row of chairs in a pachinko (Japanese upright pinball) parlor, for example, the seat part of the existing chair can be used as it is.

Although in the foregoing embodiments the present invention is applied to a support apparatus supporting the seat part of a chair rotatably and vertically movably for height adjustment, the present invention is also applicable to a support apparatus supporting a desk rotatably and adjustably in height.

Although in the foregoing embodiments a vertically movable cylinder mechanism is shown as a support column, it is also possible to use as a support column a metal rod that is not axially extendable and contractible, for example, when it is only necessary to limit the rotatable range.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The present application claims priority under 35 U.S.C. section 119 to Japanese Patent Application No. 2013-157898, filed on Jul. 30, 2013. The entire disclosure of Japanese Patent Applications No. 2013-157898, filed on Jul. 30, 2013 including specification, claims, drawings and summary is incorporated herein by reference in its entirety.

What is claimed is:

1. A support apparatus comprising:
a support tube receiving an axial load;
a support column inserted in the support tube such that one end of the support column projects out of one end of the support tube to support the load, and that an other end of the support column is axially secured to an other end of the support tube, the one end of the support column being rotatable relative to the support tube; and
a rotational position return mechanism provided between the support tube and the support column to return the support column to a reference position of the supporting column in the rotational direction relative to the support tube in response to a reduction in rotational torque applied to the one end of the support column;
the rotational position return mechanism including:
a guide member secured in the support tube so that the guide member cannot rotate relative to the support tube, and having the support column rotatably extending therethrough, the guide member having a first inclined surface formed on one axial end thereof;
a rotating member having a second inclined surface slidingly contacting the first inclined surface of the guide member, the rotating member being rotatable together with the support column and axially movable relative to the support column;
an urging member urging the rotating member axially toward the guide member; and
a limiter limiting an axial movable range of the rotating member.

2. The support apparatus of claim 1, wherein the support column is a cylinder mechanism in which a distance between the one end and the other end is axially extendable and contractible.

3. The support apparatus of claim 1, wherein the limiter includes an adjusting mechanism allowing adjustment of the axial movable range of the rotating member

4. A rotational position return apparatus comprising:
a support tube receiving an axial load;
a support column inserted in the support tube such that one end of the support column projects out of one end or the support tube to support the load, and that an other end of the support column is axially secured to an other end of the support tube, the one end of the support column being rotatable relative to the support tube;
a guide member secured in the support tube so that the guide member cannot rotate relative to the support tube, and having the support column rotatably extending therethrough, the guide member having a first inclined surface formed on one axial end thereof;
a rotating member having a second inclined surface slidingly contacting the first inclined surface of the guide member, the rotating member being rotatable together with the support column and axially movable relative to the support column;
an urging member urging the rotating member axially toward the guide member; and
a limiter limiting an axial movable range of the rotating member.

5. The rotational position return apparatus of claim 4, wherein the support column is a cylinder mechanism in which a distance between the one end and the other end of the support column is axially extendable and contractible.

6. The rotational position return apparatus of claim 4, wherein the limiter allows adjustment of the axial movable range of the rotating member.
